(19) United States
(12) Patent Application Publication
(10) Pub. No.: US 2006/0032137 A1
(43) Pub. Date: Feb. 16, 2006

(54) Catalyst coated heat exchanger

(75) Inventor: Zhi Yang Xue, Randolph, MA (US)

Correspondence Address: FISH & RICHARDSON PC, P.O. BOX 1022, MINNEAPOLIS, MN, 55440-1022, US

(73) Assignee: NUVERA FUEL CELLS, INC.

(21) Appl. No.: 11/201,002

(22) Filed: Aug. 10, 2005

Related U.S. Application Data
(60) Provisional application No. 60/600,583, filed on Aug. 11, 2004.

(51) Int. Cl. B01J 8/00

(52) U.S. Cl. 48/198.1; 48/127.9

(57) ABSTRACT

This invention relates to heat exchangers coated with a catalyst, as well as related methods and fuel reformers.

### CROSS REFERENCE TO RELATED APPLICATION

Under 35 U.S.C. § 119, this application claims priority to U.S. Provisional Application Ser. No. 60/600,583, filed Aug. 11, 2004, the contents of which are incorporated herein by reference.

### STATEMENT REGARDING FEDERALLY SPONSORED RESEARCH

This invention was made with Government support under Contract No. DE-FC02-99EE50580 awarded by the U.S. Department of Energy. The Government has certain rights in this invention.

### TECHNICAL FIELD

This invention relates to heat exchangers coated with a catalyst, as well as related methods and fuel reformers.

### BACKGROUND

Hydrogen can be made from a standard fuel, such as a liquid or gaseous hydrocarbon or alcohol, by a process including a series of reaction steps. In a first step, a fuel is typically heated together with steam, with or without an oxidant (e.g., air). The mixed gases then pass over a reforming catalyst to generate a mixture of hydrogen, carbon monoxide, carbon dioxide, and residual water via a reforming reaction. The product of this reaction is referred to as “reformate.” In a second step, the reformate is typically mixed with additional water. The water and carbon monoxide in the reformate react in the presence of a catalyst to form additional hydrogen and carbon dioxide via a water gas shift (WGS) reaction. The WGS reaction is typically carried out in two stages: a first high temperature shift (HTS) reaction stage and a second low temperature shift (LTS) reaction stage. The HTS and LTS reactions can maximize hydrogen production and reduce the carbon monoxide content in the reformate. If desired, further steps, such as a preferential oxidation (PrOx) reaction may be included to reduce the carbon monoxide content to a ppm level, e.g. 50 ppm or below. A reformate thus obtained contains a large amount of hydrogen and may be used as a fuel for a fuel cell. A device that includes reaction zones to perform the reaction steps described above is called a fuel reformer.

### SUMMARY

In one aspect, this invention features a fuel reformer containing a reforming reaction zone (e.g., an autothermal reforming reaction zone); a first heat exchanger in fluid communication and downstream of the reforming reaction zone; a first water gas shift reaction zone (e.g., a HTS reaction zone) in fluid communication and downstream of the first heat exchanger; and a second heat exchanger in fluid communication and downstream of the first water gas shift reaction zone. A surface of at least one of the first and second heat exchangers is coated with a catalyst selected from the group consisting of a combustion catalyst, a preferential oxidation catalyst, and a desulfurization catalyst.

The fuel reformer can also include a second water gas shift reaction zone (e.g., a LTS reaction zone) in fluid communication and downstream of the second heat exchanger and a preferential oxidation reaction zone in fluid communication and downstream of the second water gas shift reaction zone.

In another aspect, this invention features a fuel reformer including a heat exchanger and a preferential oxidation reaction zone downstream of the heat exchanger. A surface of the heat exchanger is coated with a catalyst selected from the group consisting of a combustion catalyst, a preferential oxidation catalyst, and a desulfurization catalyst.

In another aspect, this invention features a method that includes reacting a reformate generated from a reforming reaction with a first air stream to generate heat. The reformate and the first air stream flow outside a first heat exchanger having an outer surface coated with a first combustion catalyst or a first preferential oxidation catalyst, which facilitates the reaction between the reformate and the first air stream.

In some embodiments, the method can also include reacting the reformate with a second air stream to generate heat. The reformate and the second air stream flow outside a second heat exchanger having an outer surface coated with a second combustion catalyst or a second preferential oxidation catalyst.

In some embodiments, the method can further include heating the heat exchanger to a predetermined temperature using the heat generated from the reaction between the reformate and the air stream flowing outside the heat exchanger. The method can also include heating a reaction zone in fluid communication and downstream of the heat exchanger (e.g., a HTS reaction zone or a LTS reaction zone) to a predetermined temperature.

In some embodiments, at least a portion of the heat generated from the reaction between the reformate and the first or second air stream is transferred to a first or second cooling fluid flowing at a rate inside the first or second heat exchanger.

In some embodiments, the method can also include adjusting the flow rate of the first or second cooling fluid to maintain the predetermined temperature of the first or second heat exchanger.

In another aspect, this invention features a method for reducing the startup time of a reformer. The method includes (1) reacting a reformate generated from a reforming reaction with an air stream to generate heat, where the reformate and the air stream flow outside a heat exchanger having an outer surface coated with a combustion catalyst or a preferential oxidation catalyst, and (2) heating the heat exchanger to a predetermined temperature using the heat generated from the reaction between the reformate and the air stream during a startup process of the reformer.

In still another aspect, this invention features a method that includes flowing a reformate generated from a reforming reaction outside a heat exchanger having an outer surface coated with a desulfurization catalyst, which facilitates the removal of sulfur in the reformate.

Embodiments of fuel reformers described above can provide one or more of the following advantages.

In some embodiments, the heat generated from the oxidation reaction between a reformate and air on a surface of a heat exchanger coated with a combustion catalyst or a preferential oxidation catalyst can reduce the startup time of a reformer. The reformer startup time refers to the time required to warm up a cold reformer, i.e., the time from ignition to achieving a temperature sufficient to enable the generation of a reformate suitable for use in a fuel cell. The oxidation reaction can provide heat for (1) heating up the heat exchanger, (2) heating up the reformate so that a higher amount of heat is available to the reaction zones downstream the heat exchanger (e.g., a HTS or LTS reaction zone), and (3) generating steam in the heat exchanger for use in the fuel reforming reaction, all of which reduce the time required to warm up a cold reformer during the startup process.

In some embodiments, a heat exchanger coated with a catalyst can serve as an additional reactor in a fuel reformer, thereby reducing the catalyst volume in other reaction zones. For instance, including a heat exchanger coated with a PrOx catalyst or a desulfurization catalyst in a fuel reformer can reduce the catalyst volume required in a PrOx reaction zone or a desulfurization reaction zone.

In some embodiments, a heat exchanger coated with a catalyst enables new arrangements of the reaction zones in a reformer. For instance, conventional reformers have a series of reaction zones that are arranged so that reaction temperatures in the reaction zones decrease as the reformats travels downstream. Generally, it is not feasible to install a zone for a strongly exothermic reaction (e.g., a combustion reaction) downstream of a reforming reaction zone due to the difficulties in maintaining a proper reaction temperature. However, heat generated from a heat exchanger coated with a catalyst can be controlled by adjusting the flow rate of a cooling fluid in the heat exchanger, as well as the flow rate of an oxidant stream. For example, reaction zones in a fuel reformer can be arranged in the following sequence: a reforming reaction zone, a HTS reaction zone, a heat exchanger coated with a catalyst, a LTS reaction zone, and a PrOx reaction zone.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a plot showing the relationship between the temperature and pressure of a saturated steam.

FIG. 2 is a schematic illustration of an embodiment of an autothermal reforming process using a heat exchanger coated with a catalyst.

FIG. 3 is a schematic illustration of another embodiment of an autothermal reforming process using two heat exchangers, each of which is coated with a catalyst.

Like reference symbols in the various drawings indicate like elements.

### DETAILED DESCRIPTION

While the present invention is susceptible of embodiments in many different forms, this disclosure will describe in detail at least one preferred embodiment, and possible alternative embodiments, of the invention with the understanding that the present disclosure is to be considered merely as an exemplification of the principles of the invention and is not intended to limit the broad aspect of the invention to the specific embodiments illustrated.

In general, various reactions can be carried out in a fuel reformer at different temperatures. For example, a typical reforming reaction of methane or gasoline is conducted at a temperature in the range of about 700° C. to about 850° C., a typical HTS reaction is conducted at a temperature in the range of about 350° C. to about 450° C., a typical LTS reaction is conducted at a temperature lower than 350° C. (e.g., lower than 325° C. or lower than 300° C.), and a typical PrOx reaction is conducted at a temperature lower than 250° C. Heat exchangers can generally be used to cool the reformate between different reactions. A heat exchanger disposed between the reforming reaction zone and a HTS reaction zone is referred to hereinafter as a “reformate cooler.” A reformate cooler can be used to remove a certain amount of heat from the reformate exiting the reforming reaction zone, thereby cooling the reformate to a temperature suitable for the HTS reaction. A heat exchanger disposed between a HTS reaction zone and a LTS reaction zone is referred to hereinafter as an “intra-shift cooler” or ISC. An ISC can be used to remove a certain amount of heat from the reformate exiting the HTS reaction zone, thereby cooling the reformate to a temperature suitable for the LTS reaction.

In some embodiments, a heat exchanger can be coated with a combustion catalyst, a PrOx catalyst, or a desulfurization catalyst. A combustion catalyst can facilitate the oxidation reaction between hydrogen (e.g., in a refornate) and an oxidant (e.g., air). An example of a combustion catalyst is PROTONICS C-TYPE (Umicore, Hanau-Wolfgang, Germany). A PrOx catalyst facilitates both the oxidation reaction of carbon monoxide and the oxidation reaction of hydrogen in a reformate. A PrOx catalyst is more selective toward catalyzing carbon monoxide oxidation at a lower temperature (e.g., below 250° C.) than at a higher temperature (e.g., above 250° C.). An example of a PrOx catalyst is SELECTRA PROX I (Engelhard Corporation, Iselin, N.J.). A desulfurization catalyst can facilitate the removal of sulfur (e.g., in the form of hydrogen sulfide) from a reformate. For example, some desulfurization catalysts (e.g., zeolites) can act as an absorbent to absorb hydrogen sulfide in a reformate. Examples of such desulfurization catalysts include SELECTRA SULF-X CNG1 and SELECTRA SULF-X CNG2 (Engelhard Corporation, Iselin, N.J.). Other desulfurization catalysts (e.g., metal oxides) remove sulfur from a reformate by reacting with hydrogen sulfide to form metal sulfide.

A heat exchanger coated with a catalyst can be prepared by methods known in the art. For example, a catalyst carrier, active ingredients, and dopants can first be mixed to prepare a catalyst slurry. The catalyst slurry can then be applied to a heat transfer surface of a heat exchanger by, for example, spraying the slurry to the heat transfer surface or by dipping the heat exchanger into the slurry. The heat transfer surface is typically mechanically and/or chemically pre-treated. The coated catalyst can then be calcined at a desired temperature to form a catalyst layer on the heat transfer surface. Several catalyst layers may be required to achieve a desired catalyst loading. A catalyst can be applied onto a reformate cooler and an ISC by this method, or by any other suitable methods known in the art.

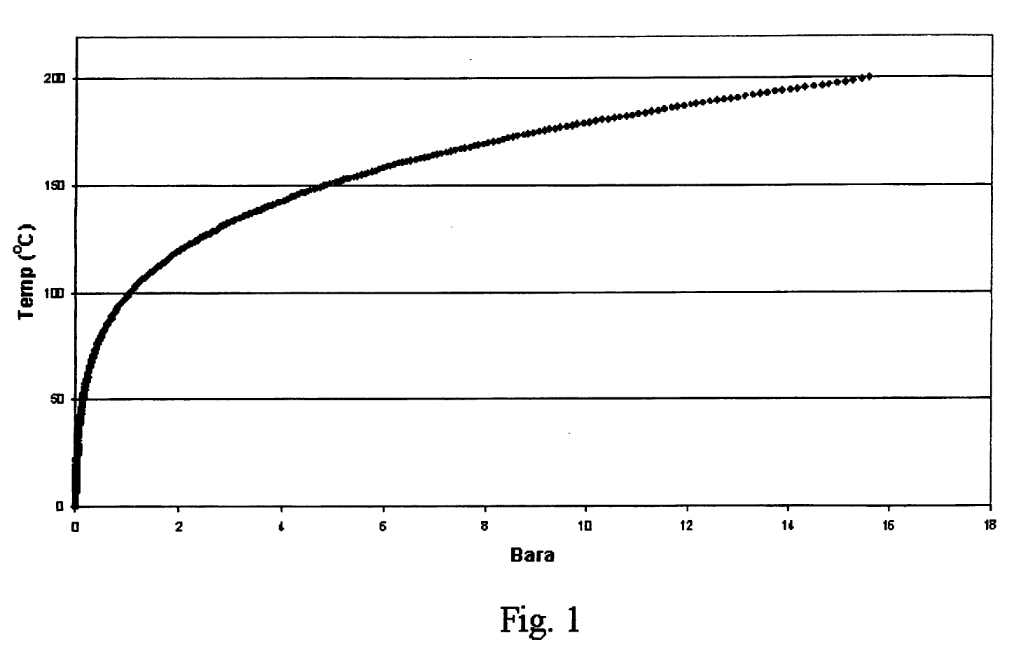

During the fuel reforming process, the temperature of the reaction occurred on a catalyst layer of a heat exchanger can be adjusted based on the reaction type and the catalyst used. For example, reformate combustion occurs in the presence of a catalyst at room temperature and completes at a temperature in the range of about 200° C. to about 300° C. Reformate preferential oxidation occurs preferably at a temperature from about 100° C. to about 250° C. (e.g., from about 150° C. to about 200° C.). Desulfurization of hydrogen sulfide occurs preferably below 300° C. (e.g., below 200° C.). One can control the reaction temperature by adjusting the flow rate of a cooling liquid inside the heat exchanger. For example, in a heat exchanger containing a two-phase cooling fluid (e.g., a gas-liquid flow), the temperature of a catalyst layer on the heat exchanger can be determined by the temperature of the cooling fluid. It is known that a two-phase flow at a fixed pressure has a fixed temperature. FIG. 1 indicates the relationship between pressure and temperature of a two-phase water-steam flow. For instance, the temperature of the two-phase flow is about 150° C. at 4.76 bara and is about 200° C. at 15.6 bara. To maintain the cooling fluid at a fixed temperature, one typically fixes the back pressure of the cooling fluid and adjusts the flow rate of the cooling fluid to maintain a two-phase flow. This temperature in turn determines the temperature at which the catalytic reaction occurs. Without wishing to be bound by any theory, it is believed that a temperature gradient exists between the catalyst layer and the cooling fluid across the heat transfer surface of the heat exchanger. Depending on the flow patterns and/or the thickness of the catalyst layer, the temperature difference between the cooling fluid and the catalyst layer is can range from a few degrees to more than 100° C. By maintaining the temperature of the cooling fluid, the temperature of the catalyst layer on a heat transfer surface can be effectively controlled. Without effective temperature control, a reaction may not occur on a heat transfer surface as intended. Exothermic reactions may even cause damages to the catalyst due to overheating.

In some embodiments, the heat generated from an oxidation reaction between a reformate and an oxidant on a heat transfer surface of a reform ate cooler or an ISC can be used to (1) heat up the reformate cooler or the ISC; (2) heat up the reformate so that a higher amount of heat will be available to the reaction zones downstream a reformate cooler (e.g., a HTS reaction) or an ISC (e.g., a LTS reaction zone); and (3) generate steam in the reformate cooler or ISC for use in the fuel reforming reaction. As a result, the time required to warm up a cold reformer during a startup process can be significantly reduced to less than 50% (e.g., less than 30%).

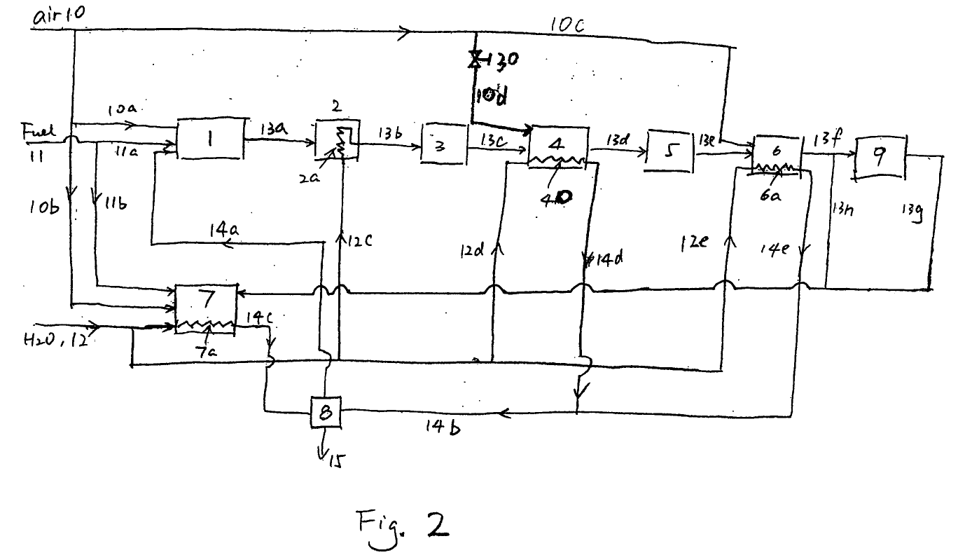

FIG. 2 is a schematic illustration of an embodiment of an autothermal reforming (ATR) process. The reactant inlet streams include air 10, fuel 11, and water 12. A portion of air stream 10a and a portion of fuel 11 a combined with steam 14a are fed into ATR reaction zone 1. The reactant mixture reacts in the presence of an ATR catalyst and forms reformate 13a at a temperature in the range of about 700° C. to about 850° C.

Reformate stream 13a then enters zone 2, which includes reformate cooler 2a. A cooling liquid 12c (e.g., water) flows inside reformate cooler 2a and exchanges heat with reformate stream 13a. Cooling liquid 12c then exits reformate cooler 2a and is allowed to be mixed with reformate stream 13a to further cool down reformate stream 13a and to obtain a desired steam to carbon ratio in the reformate stream 13a. Reformate stream 13a is typically cooled downed to a temperature within the range of about 350° C. to about 450° C. and exits reformate cooler 2a as reformate stream 13b.

Reformate 13b subsequently enters HTS reaction zone 3, in which a water gas shift reaction takes place in the presence of a HTS catalyst to convert carbon monoxide and water into carbon dioxide and hydrogen. Additional water can be added into HTS reaction zone 3 during this reaction, if desired. Since the water gas shift reaction generates heat, reformate stream 13c exiting HTS reaction zone 3 typically has a higher temperature than that of reformate stream 13b.

Before entering LTS reaction zone 5, reformate stream 13c is cooled in zone 4 having ISC 40 to a suitable temperature, typically in the range of about 250° C. to about 350° C. Air stream 10d, controlled by a flow meter 30, is supplied to zone 4. ISC 40 is coated with a layer of a catalyst, such as a combustion catalyst or a preferential oxidation catalyst to facilitate reformate combustion. ISC 40 can also be coated with a desulfurization catalyst to facilitate the removal of sulfur in reformate stream 13c. The temperature of ISC 40 is substantially determined by the temperature of exiting cooling fluid 14d, which in turn is controlled by its back pressure and flow rate. In some embodiments, the temperature of cooling fluid 14d is typically in the range of about 100° C. to about 180° C., corresponding to a steam pressure of about 1 bara to about 10 bara (see FIG. 1). The catalyst temperature can be in the range of about 110° C. to about 230° C. in a substantial portion of the ISC 40. This temperature range is suitable for catalytic combustions and PrOx reactions, as well as other catalytic reactions that require similar reaction temperatures.

Reformate stream 13d exiting ISC 40 enters LTS reaction zone 5, in which another water gas shift reaction occurs in the presence of a LTS catalyst to further reduce the carbon monoxide content in a reformate. Additional water can be added into LTS reaction zone 3 during this reaction, if desired.

Reformate stream 13e exiting LTS reaction zone 5 subsequently enters PrOx reaction zone 6 and is mixed with air stream 10c. The mixture reacts in the presence of a PrOx catalyst in zone 6, where hydrogen and carbon monoxide are catalytically combusted. A heat exchanger 6a resides in the PrOx zone 6 to transfer heat generated from the PrOx reaction to cooling fluid 12e (e.g., water). The PrOx reaction temperature is typically controlled at or below about 250° C. The heat exchanger 6a may be chosen from a variety of designs, such as a coil embedded in the PrOx catalyst pellets as described in U.S. Pat. No. 6,641,625 or as a catalyst washcoated heat exchanger as described in U.S. application Ser. No. 2004/0037758.

Reformate stream 13f having a low concentration of carbon monoxide then exits from PrOx reaction zone 6. If the concentration of carbon monoxide in reformate stream 13f is low enough to be suitable for consumption in a fuel cell (e.g. <100 ppm), it is fed into fuel cell stack 9. Reformate stream 13f passes through fuel cell anode where hydrogen in the reformate is partially consumed. The anode exhaust gas 13g is then sent to combustion chamber 7 to be combusted with air stream 10b. If the concentration of carbon monoxide exceeds a pre-determined value (e.g., >100 ppm), the entire reformate stream 13h is sent to combustion chamber 7 and combusted. The heat generated by combustion can be used to produce steam in heat exchanger 7a inside the combustion chamber 7 or can be used to provide supplemental heat energy to the reaction in ATR zone 1. In addition to combusting waste reformate, the combustion chamber can also be used for combusting fuel 11b (e.g., hydrocarbons).

FIG. 2 indicates that steam can be produced at four locations, i.e., reformate cooler 2a, ISC 40, PrOx reaction zone 6, and combustion chamber 7. The steam from the latter three can be combined at steam separator 8, in which liquid water 15 can be separated from steam and removed. Saturated steam 14a can then be sent to ATR reaction zone 1.

In some embodiments, a steam reforming process can also be carried out in the manner similar to the ATR process described in FIG. 2. The differences between a steam reforming process and an ATR process include: (1) a steam reforming catalyst instead of an ATR catalyst is used in zone 1; (2) no air stream 10a is required in zone 1; and (3) the heat required to sustain steam reforming is mainly supplied by combustion chamber 7.

A typical startup process for a reforming process is described below. Combustion chamber 7 generally fires up first to generate heat for warming up the catalyst in zone 1 and to produce steam. The reactant mixture is fed to zone 1 as soon as the catalyst therein reaches a suitable reaction temperature (e.g. above 300° C. in the case of a ATR catalyst or above 700° C. in the case of a steam reforming catalyst). The reformate generated from zone 1 passes zone 2 and enters zone 3 at a temperature within the range of about 350° C. to about 450° C., losing heat to the HTS catalyst in zone 3. It subsequently enters zone 4 in which its temperature can be further reduced to below 200° C. Consequently, there is little heat energy available for warming up LTS reaction zone 5. In the PrOx zone 6, air 10c can be turned on so that the reformate can be combusted in the presence of a PrOx catalyst to warm up zone 6. If water 12e is fed to the heat exchanger 6a, additional steam can be produced. Without a local heat source, zone 4, LTS zone 5, and PrOx reaction zone 6 are among the slowest to reach a suitable reaction temperature.

At the beginning of a cold startup, steam generation is accomplished in heat exchanger 7a in the combustion chamber 7. At startup, a smaller amount of steam is needed to support reforming at the low startup power. Once the reaction starts, it is desirable to quickly increase the power, which demands more steam production. The heat exchanger 7a alone may not be able to satisfy the increased demand for steam. However, not until zone 4 and zone 6 are warmed up can ISC 40 and PrOx heat exchanger 6a contribute to steam production. Therefore, limited steam production capacity is also one of the limiting factors in a cold startup.

An exemplary strategy for reducing the startup time is described below. Once reformate 13c enters zone 4, a predetermined amount of air 10d controlled by flow meter 30 is introduced into zone 4 and is mixed with reformate 13c flowing outside ISC 40, which is coated with a combustion catalyst or a PrOx catalyst. Water 12d can be supplied into ISC 40 before or shortly after the introduction of air 10d. Since catalytic combustion of reformate 13c is fast and limited by the availability of reactants, the flow rate of air 10d therefore determines the rate of reformate combustion as well as the rate of heat generation. During a cold startup, the heat generated from reformate combusting can first be used to warm up ISC 40 to a desired operation temperature before any extra heat is transferred to water. This can be accomplished by limiting the flow rate of water 12d until the desired temperature of ISC 40 is reached. For instance, if 10 kW of heat energy is generated from reformate combustion, a significant portion of it can first be used to heat ISC 40. This portion of energy can be reduced by increasing the flow rate of water 12d as ISC 40 warms up, and reduces to zero when ISC 40 reaches a pre-determined temperature. Subsequently, all 10 kW of the heat energy is used to generate steam, which can produce about 4 grams of saturated steam 14d per second at 5 bara. Steam 14d can then be used to supplement steam 14a as the fuel input to the reformer increases to generate more power. Such a method provides a local heat source for accelerating the warming up of zones 4 and 5 during a cold startup process. It also provides a faster power increase by producing more steam during startup.

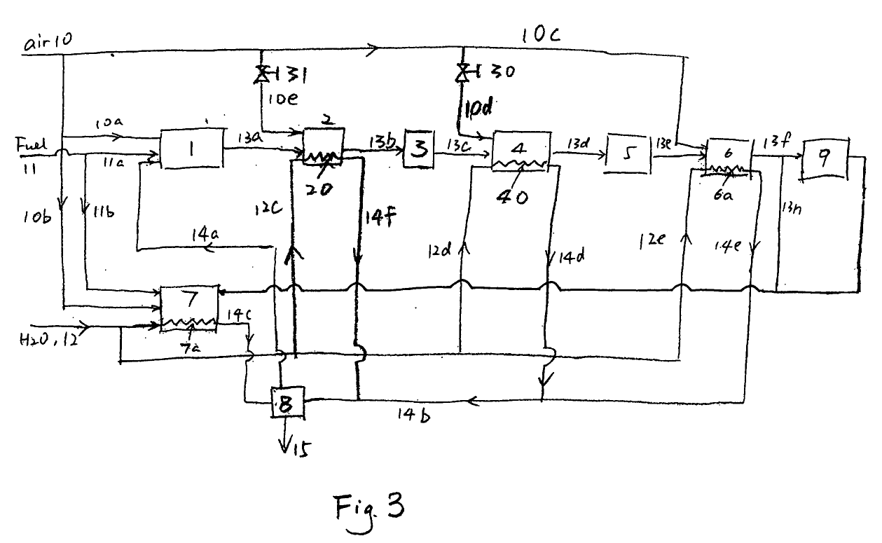

FIG. 3 illustrates another embodiment of a fuel reforming process, in which both reformate cooler 20 and ISC 40 are coated with a catalyst. In this embodiment, an air stream 10e, controlled by a flow meter 31, can be introduced to zone 2. Cooling fluid 12c (e.g., water) absorbs heat generated from the combustion of the reformate with air stream 10e. Cooling fluid 12c exits zone 2 as cooling fluid 14f. Cooling fluid 14f thus formed contains steam, which is combined with steam 14b (including 14d and 14e) and 14c, and sent to steam separator 8. It shall be noted that a catalyst can also be applied onto a heat exchanger where the cooling water exiting the heat exchanger is introduced into the reformate stream, such as heat exchanger 2a described in FIG. 2. Other methods (e.g., temperature control methods or startup methods) used in the reforming process illustrated in FIG. 3 are similar to that of the process in FIG. 2.

Further operational flexibility is achievable in a process illustrated in FIG. 3. For example, heat can be generated from heat exchangers 20 and 40 (either through a combustion reaction or a PrOx reaction) simultaneously or separately, by adjusting flow meter 30 or 31. With two additional heat sources 20 and 40, heat generation can be easily controlled to achieve a better thermal balance in the reformer.

A number of embodiments of the invention have been described. Nevertheless, it will be understood that various modifications may be made without departing from the spirit and scope of the invention. Accordingly, other embodiments are within the scope of the following claims.

What is claimed is:

1. A fuel reformer, comprising:
a reforming reaction zone;
a first heat exchanger in fluid communication and downstream of the reforming reaction zone;
a first water gas shift reaction zone in fluid communication and downstream of the first heat exchanger; and
a second heat exchanger in fluid communication and downstream of the first water gas shift reaction zone;
wherein a surface of at least one of the first and second heat exchangers is coated with a catalyst selected from the group consisting of a combustion catalyst, a preferential oxidation catalyst, and a desulfurization catalyst.

2. The reformer of claim 1, wherein a surface of the first heat exchanger is coated with the catalyst.

3. The reformer of claim 2, wherein the catalyst comprises a combustion catalyst.

4. The reformer of claim 1, wherein a surface of the second heat exchanger is coated with the catalyst.

5. The reformer of claim 4, wherein the catalyst comprises a combustion catalyst.

6. The reformer of claim 1, wherein both a surface of the first heat exchanger and a surface of the second heat exchanger are coated with the catalyst.

7. The reformer of claim 1, wherein the first water gas shift reaction zone comprises a high temperature shift reaction zone.

8. The reformer of claim 1, further comprising a second water gas shift reaction zone in fluid communication and downstream of the second heat exchanger.

9. The reformer of claim 8, wherein the second water gas shift reaction zone comprises a low temperature shift reaction zone.

10. The reformer of claim 8, further comprising a preferential oxidation reaction zone in fluid communication and downstream of the second water gas shift reaction zone.

11. The reformer of claim 1, wherein the reforming reaction zone comprises an autothermal reforming reaction zone.

12. A fuel reformer, comprising;
a heat exchanger, a surface of which is coated with a catalyst selected from the group consisting of a combustion catalyst, a preferential oxidation catalyst, and a desulfurization catalyst; and
a preferential oxidation reaction zone downstream of the heat exchanger.

13. The reformer of claim 12, wherein the catalyst comprises a combustion catalyst.

14. The reformer of claim 12, wherein the catalyst comprises a preferential oxidation catalyst.

15. The reformer of claim 12, wherein the catalyst comprises a desulfurization catalyst.

16. The reformer of claim 12, wherein the heat exchanger is disposed between a reforming reaction zone and a high temperature shift reaction zone.

17. The reformer of claim 12, wherein the heat exchanger is disposed between a high temperature shift reaction zone and a low temperature shift reaction zone.

18. A method, comprising:
reacting a reformate generated from a reforming reaction with a first air stream to generate heat, the reformate and the first air stream flowing outside a first heat exchanger having an outer surface coated with a first combustion catalyst or a first preferential oxidation catalyst, which facilitates the reaction between the reformate and the first air stream.

19. The method of claim 18, further comprising heating the first heat exchanger to a predetermined temperature using the heat generated from the reaction between the reformate and the first air stream.

20. The method of claim 19, wherein at least a portion of the heat generated from the reaction between the reformate and the first air stream is transferred to a first cooling fluid flowing at a rate inside the first heat exchanger.

21. The method of claim 20, further comprising adjusting the flow rate of the first cooling fluid to maintain the predetermined temperature of the first heat exchanger.

22. The method of claim 18, wherein the first heat exchanger is disposed between a high temperature shift reaction zone and a low temperature shift reaction zone.

23. The method of claim 22, further comprising heating the first heat exchanger and the low temperature shift reaction zone to predetermined temperatures using the heat generated from the reaction between the reformate and the first air stream.

24. The method of claim 18, wherein the first heat exchanger is disposed between a reforming reaction zone and a high temperature shift reaction zone.

25. The method of claim 24, further comprising reacting the reformate with a second air stream to generate heat, the reformate and the second air stream flowing outside a second heat exchanger having an outer surface coated with a second combustion catalyst or a second preferential oxidation catalyst, which facilitates the reaction between the reformate and the second air stream.

26. The method of claim 25, further comprising heating the second heat exchanger to a predetermined temperature using the heat generated from the reaction between the reformate and the second air stream.

27. The method of claim 26, wherein at least a portion of the heat generated from the reaction between the reformate and the second air stream is transferred to a second cooling fluid flowing at a rate inside the second heat exchanger.

28. The method of claim 27, further comprising adjusting the flow rate of the second cooling fluid to maintain the predetermined temperature of the second heat exchanger.

29. The method of claim 25, wherein the second heat exchanger is disposed between a high temperature shift reaction zone and a low temperature shift reaction zone.

30. The method of claim 29, further comprising heating the second heat exchanger and the low temperature shift reaction zone to predetermined temperatures using the heat generated from the reaction between the reformate and the second air stream.

31. A method for reducing the startup time of a reformer, comprising:
reacting a reformate generated from a reforming reaction with an air stream to generate heat, the reformate and the air stream flowing outside a heat exchanger having an outer surface coated with a combustion catalyst or a preferential oxidation catalyst, which facilitates the reaction between the reformate and the air stream; and
heating the heat exchanger to a predetermined temperature using the heat generated from the reaction between the reformate and the air stream during a startup process of the reformer.

32. The method of claim 31, wherein the heat exchanger is disposed between a reforming reaction zone and a high temperature shift reaction zone.

33. The method of claim 32, further comprising heating the high temperature shift reaction zone to a predetermined temperature using the heat generated from the reaction between the reformate and the air stream.

34. The method of claim 31, wherein the heat exchanger is disposed between a high temperature shift reaction zone and a low temperature shift reaction zone.

35. The method of claim 34, further comprising heating the low temperature shift reaction zone to a predetermined temperature using the heat generated from the reaction between the reformate and the air stream.

36. A method, comprising:
flowing a reformate generated from a reforming reaction outside a heat exchanger having an outer surface coated with a desulfurization catalyst, which facilitates the removal of sulfur in the reformats.

37. The method of claim 36, wherein the heat exchanger is disposed between a reforming reaction zone and a high temperature shift reaction zone.

38. The method of claim 36, wherein the heat exchanger is disposed between a high temperature shift reaction zone and a low temperature shift reaction zone.
